(19) United States
(12) Patent Application Publication
(10) Pub. No.: US 2018/0141080 A1
(43) Pub. Date: May 24, 2018

(54) DISCONTINUOUS COATINGS AND METHODS OF FORMING THE SAME

(71) Applicant: 3M INNOVATIVE PROPERTIES COMPANY, St. Paul, MN (US)

(72) Inventors: Seth M. Kirk, Minneapolis, MN (US); Jayshree Seth, Woodbury, MN (US); Christopher S. Lyons, St. Paul, MN (US); Brandon R. Pietz, Lakeville, MN (US)

(21) Appl. No.: 15/570,179

(22) PCT Filed: Jun. 22, 2016
(86) PCT No.: PCT/US2016/038787

§ 371 Date: Oct. 27, 2017

Related U.S. Application Data
(60) Provisional application No. 62/186,846, filed on Jun. 30, 2015.

(51) Int. Cl. B05D 1/00; B05D 1/32; B05D 3/14; B05D 5/00; B05D 7/04; B32B 3/10; B32B 3/26; B32B 7/04; B32B 7/06; B32B 7/12; B32B 27/30

(52) U.S. Cl. CPC B05D 1/60; B05D 3/067; B05D 3/147; B05D 5/00; B05D 7/04; B32B 3/10; B32B 3/263; B32B 7/045; B32B 7/06; B32B 7/12; B32B 27/308; B05D 2320/00; B05D 2401/33; B05D 2502/00; B05D 1/32

(57) ABSTRACT

Discontinuous coatings and methods of forming such coatings including transiting a substrate through a vaporization area, providing a reactant vapor comprising at least one vaporized monomer or oligomer to the vaporization area, and chemically reacting the at least one vaporized monomer or oligomer to form a discontinuous layer on the substrate, optionally wherein chemically reacting further includes polymerization. The discontinuous layer may be a patterned, semi-patterned, or random discontinuous layer.

### TECHNICAL FIELD

The present disclosure relates to discontinuous coatings and methods of forming the same, and more particularly, to discontinuous patterned coatings formed on substrates using vapor deposition methods.

### BACKGROUND

Coatings are applied to a variety of substrates for widely divergent purposes. Coatings can include adhesive coatings, primer coatings, decorative coatings, varnish coatings, among other coatings. One particular method of forming a continuous coating on a substrate uses a vacuum deposition process, such as the processes described in U.S. Pat. No. 5,440,446 (Shaw et al.) and U.S. Pat. No. 7,018,713 (Padiyath, et al.). Although various methods of forming continuous coatings on a variety of substrates are known, the art continually seeks new methods of forming coatings having particular desirable characteristics.

### SUMMARY

In one aspect, the present disclosure relates to methods of making a discontinuous coating by transiting a substrate through a vaporization area, providing a reactant vapor comprising at least one vaporized monomer or oligomer to the vaporization area, and chemically reacting the at least one vaporized monomer or oligomer to form a discontinuous layer on the substrate, optionally wherein chemically reacting further includes polymerization. In any of the foregoing embodiments, the method further includes winding the substrate with a liner positioned between a surface of the discontinuous layer and a surface of the substrate opposite the discontinuous layer. In further exemplary embodiments of any of the foregoing, the method further includes condensing at least a portion of the reactant vapor on a major surface of the substrate before reacting the at least one vaporized monomer or oligomer to produce the discontinuous layer. In some exemplary embodiments of any of the foregoing, the vaporization area is maintained at substantially atmospheric pressure.

In some exemplary embodiments, the substrate has a surface that exhibits a surface energy that is less than the surface tension of the monomer or oligomer in liquid form. In certain such embodiments, the substrate is a release liner. In further such embodiments, the release liner includes a silicone coated substrate. In additional such embodiments, the release liner includes a silicone coated polymer or copolymer film as the substrate.

In further exemplary embodiments of any of the foregoing, the discontinuous layer is a patterned discontinuous layer. In other exemplary embodiments, the discontinuous layer is a semi-patterned discontinuous layer. In still other exemplary embodiments, the discontinuous layer is a random discontinuous layer.

In certain exemplary embodiments, the reactant vapor further includes at least one photoinitiator. In some such embodiments, the at least one photoinitiator is selected from 2,2-dimethoxy-1,2,-diphenyl ethan-1-one, 1,2-hydroxy-2-methyl-1-phenyl-1-propanone, or a combination thereof.

In certain embodiments of any of the foregoing, the at least one monomer or oligomer is selected from an alkyl acrylate monomer, an alkyl methacrylate monomer, an alkyl acrylate oligomer, an alkyl methacrylate oligomer, or a combination thereof. In some such embodiments, the at least one monomer is selected from a C₁-C₃₀ alkyl acrylate or methacrylate. In certain such embodiments, the at least one oligomer exhibits a weight average molecular weight of 100-5,000 Da.

In further exemplary embodiments of any of the foregoing, the reactant vapor is substantially free of a crosslinker. In other exemplary embodiments, the reactant vapor further includes a crosslinker. In some such embodiments, the crosslinker includes a multifunctional acrylate or methacrylate. In certain such embodiments, the crosslinker is selected from Citronellyl Acrylate (CiA), 1, 6 Hexanediol Diacrylate (HDDA), Trimethylolpropane Triacrylate (TMPTA), Tripropylene Glycol Diacrylate (TRPGDA), or a combination thereof.

In additional exemplary embodiments of any of the foregoing, the reactant vapor further includes at least one monomer selected from acrylic acid, methacrylic acid, and combinations thereof. In some such embodiments, the at least one monomer comprises isooctyl acrylate and optionally, an acid monomer selected from acrylic acid, methacrylic acid, or a combination thereof. In certain such embodiments, the weight ratio of the isooctyl acrylate to the acid monomer is from 80:20 to 99.5:0.5.

In certain exemplary embodiments of any of the foregoing, reacting the at least one vaporized monomer or oligomer includes radiation curing the at least one vaporized monomer or oligomer by exposing the discontinuous layer to a radiation source selected from ultraviolet radiation, electron beam radiation, infrared radiation, radiation generated by a plasma discharge, or a combination thereof. In some such embodiments, the discontinuous layer is exposed to the radiation source for an exposure duration of from about 1 second to about one minute. In certain embodiments of any of the foregoing, a thickness of the discontinuous layer is greater than 0 micrometers, but no greater than about 250 micrometers.

In some embodiments, the method further includes treating at least a portion of the substrate with a corona treatment, wherein an untreated portion of the substrate is obscured by a mask. In certain such embodiments, the untreated portion of the substrate corresponds to a region of the substrate on which the discontinuous layer is formed.

In certain exemplary embodiments of any of the foregoing, the discontinuous layer is an adhesive layer. In some exemplary embodiments of any of the foregoing, the discontinuous layer includes a multiplicity of individual beads. In some exemplary embodiments of any of the foregoing, the method further includes transferring the discontinuous layer to a surface.

The present disclosure also relates to a discontinuous coating prepared according to any of the foregoing methods, wherein the discontinuous coating exhibits a peel force from steel as measured using the Peel Test as defined herein, of at least about 0.01 kg/cm, optionally wherein the peel force is no greater than about 0.5 kg/cm.

In another aspect, the present disclosure also relates to a discontinuous coating including a substrate, and a layer of an at least partially cured discontinuous layer of at least one monomer or oligomer deposited on a portion of a surface of the substrate, wherein the thickness of the discontinuous layer is greater than zero micrometers, and less than about 250 micrometers. In some such embodiments, the thickness of the discontinuous layer is from about 0.5 micrometers to about 10 micrometers. In certain exemplary embodiments of the foregoing discontinuous coatings, the discontinuous layer exhibits a visually identifiable pattern comprising a multiplicity of individual features.

In some such exemplary embodiments of any of the foregoing discontinuous coatings, each of the multiplicity of individual features exhibits a length that is greater than zero micrometers and less than 600 micrometers, and a width that is greater than zero micrometers and no greater than the length of that individual feature. In certain such embodiments, the multiplicity of individual features exhibit a varying number of lengths and a varying number of widths. In some exemplary embodiments of any of the foregoing discontinuous coatings, the multiplicity of individual features includes a multiplicity of individual beads, optionally wherein each individual bead is hemispherical.

In additional such exemplary embodiments of any of the foregoing discontinuous coatings, an areal density of the multiplicity of features is between 900 features per millimeter squared (mm²), and 1 feature per mm². In certain such embodiments, the discontinuous layer exhibits a peel force from steel, as measured using the Peel Test as defined herein, of at least about 0.01 kg/cm, and optionally no greater than about 0.5 kg/cm. In some such embodiments, the discontinuous layer exhibits a release force from a silicone release liner, as measured using the Release Test as defined herein, of at least between about 0.0 kg/cm to about 0.003 kg/cm, optionally wherein the release force is no greater than about 0.01 kg/cm.

In some exemplary embodiments of any of the foregoing, the discontinuous layer exhibits a pattern formed by a multiplicity of individual features, optionally wherein each individual feature exhibits a random shape. In certain such embodiments, the pattern includes an orderly arrangement of at least a portion of the multiplicity of individual features. In other exemplary embodiments, the discontinuous layer includes a random arrangement of at least a

[symbol]

### Listing of Exemplary Embodiments:

A. A method of making a coating, comprising:

transiting a substrate through a vaporization area;

providing a reactant vapor comprising at least one vaporized monomer or oligomer to the vaporization area; and

chemically reacting the at least one vaporized monomer or oligomer to form a discontinuous layer on the substrate, optionally wherein chemically reacting further comprise polymerization.
B. The method of claim A, wherein the substrate comprises a surface that comprises a surface energy that is less than the surface tension of the monomer or oligomer.
C. The method of claim A, wherein the substrate comprises a release liner.
D. The method of claim C, wherein the release liner is a silicone coated liner.
E. The method of any one of claims A-D, wherein the discontinuous layer is a patterned discontinuous layer.
F. The method of any one of claims A-D, wherein the discontinuous layer is a semi-patterned discontinuous layer.
G. The method of any one of claims A-D, wherein the discontinuous layer is a random discontinuous layer.
H. The method of claim D, wherein the liner is a silicone coated polymer or copolymer film.
I. The method of any preceding claim, further comprising winding the substrate with a liner positioned between a surface of the discontinuous layer and a surface of the substrate opposite the discontinuous layer.
J. The method of any preceding claim, wherein the vaporization area is maintained at substantially atmospheric pressure.
K. The method of any preceding claim, wherein the reactant vapor further comprises at least one photoinitiator.
L. The method of claim K, wherein the at least one photoinitiator is selected from 2,2-dimethoxy-1,2,-diphenyl ethan-1-one, 1,2-hydroxy-2-methyl-1-phenyl-1-propanone, or a combination thereof.
M. The method of any preceding claim, wherein the at least one monomer or oligomer is selected from an alkyl acrylate monomer, an alkyl methacrylate monomer, an alkyl acrylate oligomer, an alkyl methacrylate oligomer, or a combination thereof.
N. The method of claim M, wherein the at least one monomer is selected from a C₁-C₃₀ alkyl acrylate or methacrylate.
O. The method of claim M, wherein the at least one oligomer exhibits a weight average molecular weight of 100-5,000 Da.
P. The method of claim M, wherein the reactant vapor is substantially free of a crosslinker.
Q. The method of claim M, wherein the reactant vapor further comprises a crosslinker.
R. The method of claim Q, wherein the crosslinker comprises a multifunctional acrylate or methacrylate.
S. The method of claim Q, wherein the crosslinker is selected from Citronellyl Acrylate (CiA), 1, 6 Hexanediol Diacrylate (HDDA), Trimethylolpropane Triacrylate (TMPTA), Tripropylene Glycol Diacrylate (TRPGDA), or a combination thereof.
T. The method of any preceding claim, wherein the reactant vapor further comprises at least one monomer selected from acrylic acid, methacrylic acid, and combinations thereof.
U. The method of any preceding claim, wherein the at least one monomer comprises isooctyl acrylate and optionally, an acid monomer selected from acrylic acid, methacrylic acid, or a combination thereof.
V. The method of claim U, wherein the weight ratio of the isooctyl acrylate to the acid monomer is from 80:20 to 99.5:0.5.
W. The method of any preceding claim, further comprising condensing at least a portion of the reactant vapor on a major surface of the substrate before reacting the at least one vaporized monomer or oligomer to produce the discontinuous layer.
X. The method of claim W, wherein reacting the at least one vaporized monomer or oligomer comprises radiation curing the at least one vaporized monomer or oligomer by exposing the discontinuous layer to a radiation source selected from ultraviolet radiation, electron beam radiation, infrared radiation, radiation generated by a plasma discharge, or a combination thereof.
Y. The method of claim X, wherein the discontinuous layer is exposed to the radiation source for an exposure duration of from about 1 second to about one minute.
Z. The method of any preceding claim, wherein a thickness of the discontinuous layer is greater than 0 micrometers, but no greater than about 250 micrometers.
AA. The method of any preceding claim, further comprising treating at least a portion of the substrate with a corona treatment, wherein an untreated portion of the substrate is obscured by a mask.
BB. The method of claim AA, wherein the untreated portion of the substrate corresponds to a region of the substrate on which the discontinuous layer is formed.
CC. The method of any preceding claim, wherein the discontinuous layer is an adhesive layer.
DD. The method of any preceding claim, wherein the discontinuous layer comprises a plurality of individual beads.
EE. The method of any preceding claim, further comprising transferring the discontinuous layer to a surface.
FF. A discontinuous coating prepared according to the method of any preceding claim, wherein the discontinuous coating exhibits a peel force from steel as measured using the Peel Test as defined herein, of at least about 0.01 kg/cm, optionally wherein the peel force is no greater than about 0.5 kg/cm.
GG. A discontinuous coating, comprising:

a. a substrate;

b. a layer of an at least partially cured discontinuous layer of at least one monomer or oligomer deposited on a portion of a surface of the substrate, wherein the thickness of the discontinuous layer is greater than zero micrometers, and less than about 250 micrometers.
HH. The discontinuous coating of claim GG, wherein the thickness of the discontinuous layer is from about 0.5 micrometers to about 10 micrometers.
II. The discontinuous coating of any one of claims GG-HH, wherein the discontinuous layer exhibits a visually identifiable pattern comprising a plurality of individual features.
JJ. The discontinuous coating of claim II, wherein each of the plurality of individual features exhibits a length that is greater than zero micrometers and less than 600 micrometers, and a width that is greater than zero micrometers and no greater than the length of that individual feature.
KK. The discontinuous coating of claim II, wherein the plurality of individual features exhibit a varying number of lengths and a varying number of widths.
LL. The discontinuous coating of claim II, wherein the plurality of individual features comprise a plurality of individual beads, optionally wherein each individual bead is hemispherical.
MM. The discontinuous coating of any one of claims GG-LL, wherein an areal density of the plurality of features is between 900 features per millimeter squared (mm²), and 1 feature per mm².
NN. The discontinuous coating of any one of claims GG-MM, wherein the discontinuous layer exhibits a peel force from steel, as measured using the Peel Test as defined herein, of at least about 0.01 kg/cm, and optionally no greater than about 0.5 kg/cm.
OO. The discontinuous coating of any one of claims GG-NN, wherein the discontinuous layer has a release force from a silicone release liner, as measured using the Release Test as defined herein, of at least between about 0.0 kg/cm to about 0.003 kg/cm, optionally wherein the release force is no greater than about 0.01 kg/cm.
PP. The discontinuous coating of any one of claims GG-OO, wherein the discontinuous layer exhibits a pattern formed by a plurality of individual features, optionally wherein each individual feature exhibits a random shape.
QQ. The discontinuous coating of claim PP, wherein the pattern comprises an orderly arrangement of at least a portion of the plurality of individual features.
RR. The discontinuous coating of any one of claims GG-OO, wherein the discontinuous layer comprises a random arrangement of at least a portion of the plurality of individual features.

Various aspects and advantages of exemplary embodiments of the disclosure have been summarized. The above Summary is not intended to describe each illustrated embodiment or every implementation of the present certain exemplary embodiments of the present disclosure. The Drawings and the Detailed Description that follow more particularly exemplify certain preferred embodiments using the principles disclosed herein.

### BRIEF DESCRIPTION OF THE DRAWINGS

The disclosure may be more completely understood in consideration of the following detailed description of various embodiments of the disclosure in connection with the accompanying figures, in which:

FIG. 1 is a cross sectional view of a substrate and a discontinuous coating thereon according to exemplary embodiments of the present disclosure.

FIGS. 2A-2C are photomicrographs showing a top view of discontinuous coatings on a substrate according to exemplary embodiments of the present disclosure.

FIGS. 3A-3Dare photomicrographs showing a top view of discontinuous coatings on a substrate according to additional exemplary embodiments of the present disclosure.

FIGS. 4A-4D are photomicrographs showing a top view of discontinuous coatings on a substrate according to other exemplary embodiments of the present disclosure.

FIGS. 5A-5D are photomicrographs showing a top view of discontinuous coatings on a substrate according to further exemplary embodiments of the present disclosure.

FIGS. 6A-6D are photomicrographs showing a top view of discontinuous coatings on a substrate according to still other exemplary embodiments of the present disclosure.

In the drawings, like reference numerals indicate like elements. While the above-identified drawing, which may not be drawn to scale, sets forth various embodiments of the present disclosure, other embodiments are also contemplated, as noted in the Detailed Description. In all cases, this disclosure describes the presently disclosed disclosure by way of representation of exemplary embodiments and not by express limitations. It should be understood that numerous other modifications and embodiments can be devised by those skilled in the art, which fall within the scope and spirit of this disclosure.

### DETAILED DESCRIPTION

As used in this specification and the appended embodiments, the singular forms “a”, “an”, and “the” include plural referents unless the content clearly dictates otherwise. Thus, for example, reference to “a reactant vapor” can include one or more reactant vapors. As used in this specification and the appended embodiments, the term “or” is generally employed in its sense including “and/or” unless the content clearly dictates otherwise.

As used in this specification, the recitation of numerical ranges by endpoints includes all numbers subsumed within that range (e.g. 1 to 5 includes 1, 1.5, 2, 2.75, 3, 3.8, 4, and 5).

Unless otherwise indicated, all numbers expressing quantities or ingredients, measurement of properties and so forth used in the specification and embodiments are to be understood as being modified in all instances by the term “about.” Accordingly, unless indicated to the contrary, the numerical parameters set forth in the foregoing specification and attached listing of embodiments can vary depending upon the desired properties sought to be obtained by those skilled in the art utilizing the teachings of the present disclosure. At the very least, and not as an attempt to limit the application of the doctrine of equivalents to the scope of the claimed embodiments, each numerical parameter should at least be construed in light of the number of reported significant digits and by applying ordinary rounding techniques.

For the following Glossary of defined terms, these definitions shall be applied for the entire application, unless a different definition is provided in the claims or elsewhere in the specification.

### Glossary

The terms “about” or “approximately” with reference to a numerical value or a shape means +/−five percent of the numerical value or property or characteristic, but expressly includes the exact numerical value. For example, a pressure of “about” 1 kg/cm refers to a pressure from 0.95 to 1.05 kg/cm, but also expressly includes a pressure of exactly 1 kg/cm. Similarly, a perimeter that is “substantially square” is intended to describe a geometric shape having four lateral edges in which each lateral edge has a length which is from 95% to 105% of the length of any other lateral edge, but which also includes a geometric shape in which each lateral edge has exactly the same length.

The term “copolymer” includes random, block and star (e.g. dendritic) copolymers.

The term “substantially” with reference to a property or characteristic means that the property or characteristic is exhibited to a greater extent than the opposite of that property or characteristic is exhibited. For example, a substrate that is “substantially” transparent refers to a substrate that transmits more radiation (e.g. visible light) than it fails to transmit (e.g. absorbs and reflects). Thus, a substrate that transmits more than 50% of the visible light incident upon its surface is substantially transparent, but a substrate that transmits 50% or less of the visible light incident upon its surface is not substantially transparent.

The term “discontinuous” with reference to a layer means that the layer is broken, intermittent, irregular, uneven, or the like, so that it does not cover the entire underlying surface on which the layer rests.

The term “patterned discontinuous layer” means a layer having a visually identifiable pattern formed by a plurality of individual features.

The term “semi-patterned discontinuous layer” means a layer having a visually identifiable pattern formed by a plurality of individual features over a portion of an area, with a remaining portion of the area with substantially no visually identifiable pattern formed by a plurality of individual features.

The term “random discontinuous layer” means a discontinuous layer which is not a patterned discontinuous layer or a semi-patterned discontinuous layer.

The term “Peel Test” with reference to a property or characteristic means a test method that measures the force required to remove an adhesive attached to a backing from a surface.

The term “Release Test” means a test method that measures the force required to remove a release layer from a cured adhesive, measured at a specific angle and rate of removal.

The term “Contact angle” refers to a way to measure a wettability of a surface or material. The contact angle can represent how a liquid deposited on a substrate spreads across the substrate and/or how the liquid deposited on the substrate forms individual features or boundary surfaces. Generally, liquids with a relatively lower contact angle can have a greater “wetting” capability and are more likely to form continuous coatings compared to liquids with a relatively high contact angle.

The term “visually identifiable” with reference to a property or characteristic means capable of being identified visually through the assistance of a viewing device, such as a microscope, that allows for magnification of objects between 1 micrometers and 250 micrometers.

The term “adjoining” with reference to a particular layer means joined with or attached to another layer, in a position wherein the two layers are either next to (i.e., adjacent to) and directly contacting each other, or contiguous with each other but not in direct contact (i.e., there are one or more additional layers intervening between the layers).

By using terms of orientation such as “atop”, “on”, “over”, “covering”, “uppermost”, “underlying”, and the like for the location of various elements in the disclosed coated articles, we refer to the relative position of an element with respect to a horizontally-disposed, upwardly-facing substrate. However, unless otherwise indicated, it is not intended that the substrate or articles should have any particular orientation in space during or after manufacture.

By using the term “overcoated” to describe the position of a layer with respect to a substrate or other element of an article of the present disclosure, we refer to the layer as being atop the substrate or other element, but not necessarily contiguous to either the substrate or the other element.

Various exemplary embodiments of the disclosure will now be described with particular reference to the Drawings. Exemplary embodiments of the present disclosure may take on various modifications and alterations without departing from the spirit and scope of the disclosure. Accordingly, it is to be understood that the embodiments of the present disclosure are not to be limited to the following described exemplary embodiments, but are to be controlled by the limitations set forth in the claims and any equivalents thereof.

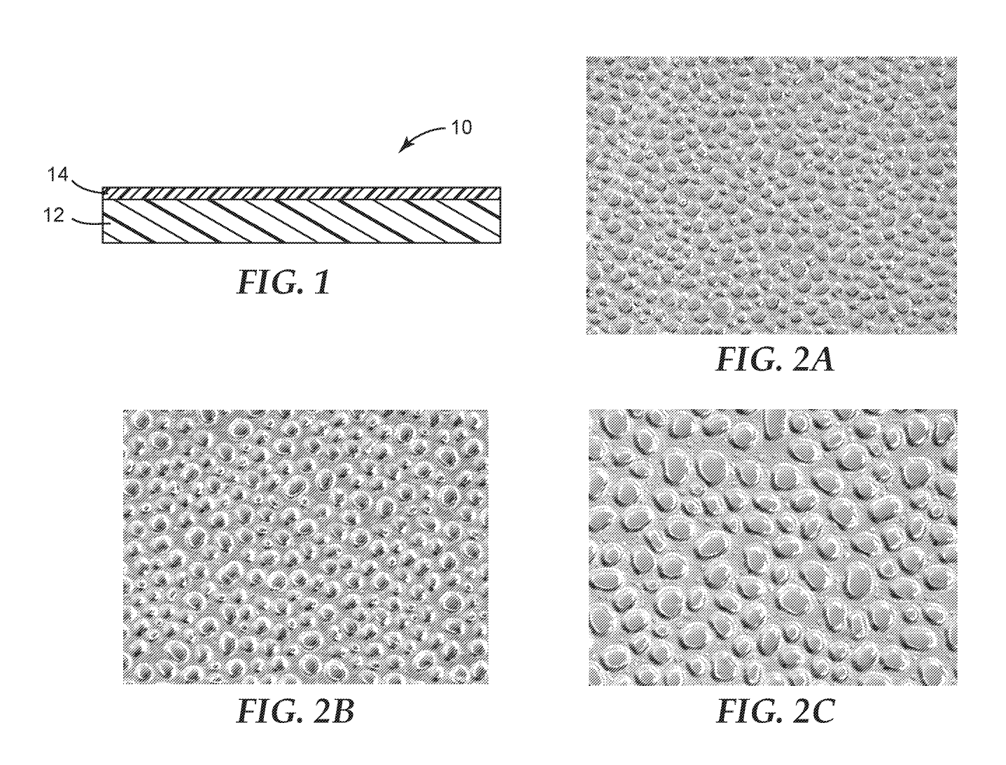

In one exemplary embodiment, the present disclosure describes discontinuous coatings and methods of forming the same. Referring to FIG. 1, an article 10 is shown, the article 10 comprising a substrate 12, and a discontinuous layer 14 coated on the substrate 12. The discontinuous layer 14 can be generated by vapor coating processes. Exemplary vapor coating processes are described in, for example, U.S. Pat. No. 6,045,864.

The vapor coating processes are based upon the concept of vaporizing (e.g., utilizing a vaporization process) a fluid coating composition, which preferably is solvent-free. In some examples, the vaporized fluid coating composition can include a reactant vapor comprising at least one vaporized monomer or oligomer.

After vaporization, the vapor flows to a substrate to be coated in a vaporization area. The vaporization area can include an area where the vapor condenses on the substrate. In some examples, a substrate is transited through a vaporization area. The substrate is maintained at a temperature below the condensation point of the vapor. This causes the vapor to condense as a thin coating layer that can be subsequently cured, if desired, by various curing mechanisms.

The vapor coating processes are particularly useful for forming thin films having a thickness in the range from about 0 micrometers to about 250 micrometers. Thicker coatings can be formed by increasing the exposure time of the substrate to the vapor, increasing the flow rate of the fluid composition, increasing the temperature of the carrier gas, and/or increasing the pressure of the carrier gas. For flexible web substrates, increasing the exposure time of the substrate to the vapor can be achieved by adding multiple vapor sources to the system or by decreasing the speed of the substrate through the system. Layered coatings of different materials can be formed by sequential coating depositions using a different coating material with each deposition.

In some embodiments, the vapor coating processes may be practiced at vacuum pressure. However, it can be advantageous to utilize the vapor coating processes at substantially ambient or at substantially atmospheric pressure. That is, the vaporization and coating can occur at any desired pressure, including ambient pressure. This avoids the need to rely upon costly vacuum chambers commonly used in other known vapor coating processes. As another advantage, vaporization and coating can occur at relatively low temperatures, so that temperature sensitive materials can be coated without degradation that might otherwise occur at higher temperatures.

Generally, vaporization of the fluid coating composition can be accomplished using any atomization technique or vaporization technique known in the art. Suitable vapor sources are disclosed in U.S. Pat. Pub. No. 2014/178567, and may include, for example, heated baths, bubblers, atomizers, cyclone evaporators, ultrasonic evaporators, wiped-film evaporators, rolled film evaporators, spinning disk evaporators, rotary evaporators, porous frit evaporators, tubular evaporators, and the like. In various embodiments, the vapor source may include one or more of the vapor sources described in the following patents and publications, incorporated by reference herein in their entireties: U.S. Pat. No. 7,300,538 (Lemme et al.); U.S. Pat. No. 6,245, 150 (Lyons et al.); U.S. Pat. No. 4,954,371 (Yializis et al.); U.S. Pat. No. 5,653,813 (Benzing et al.); U.S. Pat. No. 5,595,603 (Klinedinst et al.); U.S. Pat. No. 5,536,323 (Kirlin et al.); U.S. Pat. No. 5,431,736 (Boer et al.); U.S. Pat. No. 5,356,451 (Cain et al.); U.S. Pat. No. 5,558,687 (Cain et al.); U.S. Pat. No. 5,951,923 (Horie et al.); U.S. Pat. No. 6,089,548 (Plitzner et al.); U.S. Pat. No. 6,157,774 (Komino et al.); U.S. Pat. No. 6,958,107 (Clarke et al.); U.S. Pat. No. 6,409,839 (Sun et al.); U.S. Pat. No. 6,488,985 (Honda et al.); U.S. Pat. Pub. No. 2007/0120275 (Liu et al.); U.S. Pat. Pub. No. 2008/0017110 (Kim et al.); U.S. Pat. Pub. No. 2008/0108180 (Charles, et al.); and U.S. Pat. Pub. No. 2008/0292810 (Anderson, et al).

While the present disclosure is described with respect to a single vapor source, it is to be appreciated that any number of additional vapor sources may be utilized. For example, a plurality of vapor sources may be useful in embodiments in which a vapor mixture is desired and vaporization of two or more components of the vapor mixture in a single vapor source is difficult or impracticable (e.g., due to varying vapor pressure curves, immiscibility of the components in a liquid state, or undesirable reactions of components in liquid state).Various exemplary embodiments of the disclosure will now be described with particular reference to the Drawings. Exemplary embodiments of the disclosure may take on various modifications and alterations without departing from the spirit and scope of the disclosure. Accordingly, it is to be understood that the embodiments of the disclosure are not to be limited to the following described exemplary embodiments, but is to be controlled by the limitations set forth in the claims and any equivalents thereof.

Forming a discontinuous layer includes transiting a substrate through a vaporization area. As described herein, the vaporization area includes an area where a reactant vapor is present and the reactant vapor can interact with the substrate. In some examples, the reactant vapor can comprise at least one monomer or oligomer that is vaporized or atomized.

In some examples, the discontinuous layer is formed with a substrate that comprises a surface that comprises a surface energy that is less than the surface tension of the monomer or oligomer. The lower surface energy of the surface of the substrate causes the vaporized reactant comprising the monomer or oligomer to “bead up” when deposited on the surface of the substrate and form a plurality of individual features on the surface of the substrate. In contrast to previous systems and methods of forming coatings that are substantially uniform, the discontinuous layer comprises a plurality of individual features (e.g., beads) that are separate and distinct features. The plurality of individual features provide advantageous properties (e.g., peel force, etc.) compared to the previous methods of forming a uniform layer of monomer or oligomer on the surface of a substrate.

The surface energy of the substrate and the surface tension of the monomer or oligomer can produce individual features as described further herein. The individual features can be formed due to the wettability of the deposited monomer on the substrate. As described herein, the wettability of the deposited monomer or oligomer can be related to the contact angle of the deposited monomer or oligomer. As referenced herein, the contact angle is a measurement of a wettability of a liquid to a particular surface. Thus, the lower surface energy of the substrate compared to the deposited monomer or oligomer creates a non-zero contact angle of the deposited monomer or oligomer, which allow the deposited monomer or oligomer the ability to form a plurality of features and boundary surfaces.

In some examples, the at least one monomer or oligomer of the reactant vapor is selected from an alkyl acrylate monomer, an alkyl methacrylate monomer, an alkyl acrylate oligomer, an alkyl methacrylate oligomer, or a combination thereof. In certain embodiments, the at least one monomer is selected from a C₁-C₃₀ alkyl acrylate or methacrylate. In some examples, the at least one oligomer exhibits a weight average molecular weight of 100-5,000 Da. In certain examples, the reactant vapor further comprises at least one monomer selected from acrylic acid, methacrylic acid, and combinations thereof. In some embodiments, the at least one monomer comprises isooctyl acrylate and optionally, an acid monomer selected from acrylic acid, methacrylic acid, or a combination thereof.

The reactant vapor can comprise a weight ratio between the isooctyl acrylate and an acid monomer. In some examples, the weight ratio of the isooctyl acrylate to the acid monomer is from 80:20 to 99.5:0.5. In certain examples, the weight ratio of the isooctyl acrylate to the acid monomer is 90:10.

In certain examples, the reactant vapor can further include a crosslinker that is a multifunctional acrylate or methacrylate. In some example, the crosslinker is selected from Citronellyl Acrylate (CiA), 1, 6 Hexanediol Diacrylate (HDDA), Trimethylolpropane Triacrylate (TMPTA), Tripropylene Glycol Diacrylate (TRPGDA), or a combination thereof. However, it can be advantageous in some examples for the reactant vapor to include substantially no crosslinker. In some examples, the discontinuous coating can exhibit relatively high peel forces without the use of the crosslinker. In some examples, the discontinuous layer exhibits a peel force from steel, as measured using the Peel Test as defined herein, of at least about 0.01 kg/cm, and optionally no greater than about 0.5 kg/cm. In addition, in certain examples, the discontinuous layer has a peel force from a silicone release liner, as measured using the Release Test as defined herein, of at least between about 0.0 kg/cm to about 0.003 kg/cm, optionally wherein the peel force is no greater than about 0.01 kg/cm.

In some examples, the reactant vapor further comprises at least one photoinitiator. The photoinitiator can be a compound that is added to the reactant vapor. The photoinitiator can be a compound that decomposes into a number of free radicals when exposed to light. In some examples, the photoinitiator can be utilized to promote the polymerization of the deposited monomer or oligomer. In certain examples, the photoinitiator is selected from Irgacure® 651 (2,2-dimethoxy-1,2-diphenyl ethan-1-one) and Irgacure® 1173 (1, 2-hydroxy-2-methyl-1-phenyl-1-propanone), or a combination thereof.

In some examples, the discontinuous coatings can be formed by transiting a substrate through a vaporization area. The vaporization area can include an area where a vaporized reactant (e.g., reactant vapor) comprising at least one vaporized monomer or oligomer exists. That is, a reactant vapor can be provided to the vaporization area and the substrate can interact with the reactant vapor as described herein. Examples of utilizing a vaporization area to deposit the vaporized reactant are described in, for example, U.S. Pat. No. 6,045,864. As described herein, it can be advantageous to have the vaporization area be at substantially atmospheric pressure so that a vacuum pump is not needed to maintain the vaporization area under vacuum.

In some examples, the substrate can include a release liner. The release liner can comprise a polymer that is used to prevent the deposited vaporized monomer or oligomer from prematurely adhering to an unwanted surface. Utilizing a release liner to prevent premature adhering is described in, for example, U.S. Pat. No. 6,045,864. In certain examples, the release liner is a silicone coated release liner. That is, the release liner is coated with a silicone based material prior to utilizing the release liner. In some examples, the discontinuous layer can be transferred to a layer. For example, the discontinuous layer can be transferred to a film.

The discontinuous coatings can be formed by chemically reacting the at least one vaporized monomer or oligomer to form a discontinuous layer on the substrate. In certain examples, chemically reacting can further comprise polymerization of the at least one vaporized monomer or oligomer. The discontinuous layer includes a deposited layer of vaporized monomer or oligomer on the substrate that includes individual features instead of a substantially uniform layer. In some examples, the individual features exhibit a visually identifiable pattern. That is, the discontinuous layer exhibits a visually identifiable pattern comprising a plurality of individual features. Examples of chemically reacting the at least one vaporized monomer or oligomer to form a layer on a substrate are described in, for example, U.S. Pat. No. 6,045,864. However, the previous systems and methods describe processes of forming a uniform layer of monomer or oligomer on the substrate.

Forming the discontinuous coating can include winding the substrate with a liner positioned between a surface of the discontinuous layer and a surface of the substrate opposite the discontinuous layer. In certain examples, the liner and/or the release liner is a silicone coated polymer or copolymer film, optionally wherein the polymer or copolymer film comprises at least one of polyethylene terephthalate (PET), polyethylene naphthalate (PEN), polybutylene terephthalate (PBT), or a polyolefin.

Forming the discontinuous coating can include condensing at least a portion of the reactant vapor on a major surface of the substrate before reacting the at least one vaporized monomer or oligomer to produce the discontinuous layer. In certain examples, forming the discontinuous coating further comprises reacting the at least one vaporized monomer or oligomer with radiation curing. Radiation curing of the at least one vaporized monomer or oligomer includes exposing the discontinuous layer to a radiation source selected from ultraviolet radiation, electron beam radiation, infrared radiation, radiation generated by a plasma discharge, or a combination thereof. In certain examples, the radiation curing includes exposing the discontinuous layer to a radiation source for an exposure duration from about one second to about one minute. Further examples of radiation curing are described in, for example, U.S. Pat. No. 6,045,864.

In some examples, forming the non-continuous coating further comprises treating at least a portion of the substrate with an electrical discharge treatment. The electrical discharge treatment can include a radio-frequency plasma, glow discharge, atmospheric pressure plasma, dielectric barrier discharge, corona discharge, jet plasma, or surface discharge treatment to modify a surface of the substrate. The electrical discharge treatment can include a treatment that can increase adhesion or wettability properties of the substrate prior to the substrate being transited through the vaporization area. In some examples, an untreated portion of the substrate is obscured by a mask to prevent the electrical discharge treatment from modifying the surface of the masked portion of the substrate. In certain examples, the portion of the substrate that is masked from the electrical discharge treatment can correspond to a region of the substrate on which the non-continuous layer is formed. That is, the reactant vapor comprising the at least one monomer or oligomer is deposited on the region of the substrate that is not treated by the electrical discharge treatment. Further examples of electrical discharge treatments are described in, for example, U.S. Pat. No. 6,045,864.

As described herein, the discontinuous coating can include a plurality of individual features (e.g., beads, shapes, etc.). The individual features can include a plurality of individual features that each exhibit a particular length and a particular width defined by an area of substrate with substantially no deposited monomer or oligomer. For example, the individual features can exhibit a length that is greater than zero micrometers and less than 600 micrometers, and a width that is greater than zero micrometers and no greater than the length of that individual feature. In certain examples, the individual features can each exhibit a varying number of lengths and a varying number of widths. That is, a first individual feature can exhibit a first corresponding length and a first corresponding width while a second individual feature can exhibit a second corresponding length that is different than the first corresponding length of the first individual feature with a second corresponding width that is different than the first corresponding width of the first individual feature.

In some examples, the individual features can comprise a plurality of individual beads, optionally wherein each individual bead is hemispherical. In some examples, the plurality of individual features can each exhibit a different shape. That is, in some examples, the discontinuous layer exhibits a pattern formed by a plurality of individual features. That is, the discontinuous layer can exhibit a visually identifiable patterned discontinuous layer. In some examples, each of the individual features can exhibit a substantially different shape or substantially random shape. The substantially random shapes for each of the plurality of individual features can exhibit a visually identifiable random arrangement or random pattern. In certain examples, the pattern comprises an orderly arrangement of at least a portion of the plurality of individual features. That is, the discontinuous layer can exhibit a semi-patterned discontinuous layer of individual features.

As described herein, the individual features are visually identifiable with an area of substrate between each of the individual features where the at least one monomer or oligomer is not deposited. That is, in one example, each individual feature can be separated from other individual features by an area of substrate with less deposited monomer or oligomer. In another example, each individual feature can be separated from other individual features by an area of substrate with substantially no deposited monomer or oligomer.

In certain examples, the individual features each exhibit a hemispherical shape that resemble a plurality of individual beads. In certain examples, the individual features have an areal density of the plurality of features is between 900 features per millimeter squared (mm²), and 1 feature per mm². In some examples, the hemispherical shape may be “flattened” when winding the substrate with a liner positioned between the surface of the discontinuous layer and a surface of the substrate opposite the discontinuous layer. That is, the individual features can appear in a “pancake-shape” where a top portion of the individual features are “flattened” by a liner and the surrounding edges of the features appear rounded due to a pressure applied when winding the substrate and individual features with a liner. In certain examples, the individual features can exhibit a “flattened” hemispherical shape when deposited on the substrate even prior to winding the substrate with a liner positioned between the surface of the discontinuous layer and a surface of the substrate opposite the discontinuous layer.

In some examples, the individual features can each comprise a particular height or thickness. In addition, the individual features can comprise an average height or thickness. In some examples, the thickness of the discontinuous layer (e.g., plurality of individual features) is greater than 0 micrometers, but no greater than about 250 micrometers.

The formed discontinuous coating as described herein can provide a discontinuous coating. In some examples, the discontinuous coating exhibits a peel force from steel as measured using the Peel Test as defined herein, of at least about 0.01 kg/cm, optionally wherein the peel force is no greater than about 0.5 kg/cm. In certain examples, the discontinuous coating exhibits a peel force from steel as measured using the Peel Test as defined herein, of at least about 0.01 kg/cm, optionally wherein the peel force is no greater than about 0.0.5 kg/cm. The discontinuous coating can comprise a substrate as described herein. In some examples, the discontinuous coating can include a layer of an at least partially cured discontinuous layer of at least one monomer or oligomer deposited on a portion of a surface of the substrate, wherein the thickness of the discontinuous layer is greater than zero micrometers, and less than about 250 micrometers.

In some examples, the discontinuous coating can have a thickness from about 0.5 micrometers to about 10 micrometers. As described herein, the thickness of the discontinuous coating can include an average thickness of the plurality of individual features deposited on the substrate. In some examples, the adhesive coating can exhibit a visually identifiable pattern comprising the plurality of individual features. As described herein, the identifiable pattern can comprise at least one of: a patterned discontinuous layer, a semi-patterned discontinuous layer, a random discontinuous layer, or a combination thereof.

In some examples, the plurality of individual features of the discontinuous coating exhibits a length that is greater than zero micrometers and less than 600 micrometers, and a width that is greater than zero micrometers and no greater than the length of that individual feature. In certain examples, the plurality of individual features exhibit a varying number of lengths and a varying number of widths.

The operation of the present disclosure will be further described with regard to the following detailed examples. These examples are offered to further illustrate the various specific and preferred embodiments and techniques. It should be understood, however, that many variations and modifications may be made while remaining within the scope of the present disclosure.

### EXAMPLES

These Examples are merely for illustrative purposes and are not meant to be overly limiting on the scope of the appended claims. Notwithstanding that the numerical ranges and parameters setting forth the broad scope of the present disclosure are approximations, the numerical values set forth in the specific examples are reported as precisely as possible. Any numerical value, however, inherently contains certain errors necessarily resulting from the standard deviation found in their respective testing measurements. At the very least, and not as an attempt to limit the application of the doctrine of equivalents to the scope of the claims, each numerical parameter should at least be construed in light of the number of reported significant digits and by applying ordinary rounding techniques.

### Summary of Materials

Unless otherwise noted, all parts, percentages, ratios, etc. in the Examples and the rest of the specification are by weight. Solvents and other reagents used may be obtained from Sigma-Aldrich Chemical Company (Milwaukee, Wis.) unless otherwise noted. In addition, Table 1 provides abbreviations and a source for all materials used in the Examples below:

TABLE 1

| Abbreviation | Description | Source |
|---|---|---|
| AA | Acrylic Acid | Sigma-Aldrich Chemical |
| | | Company (Milwaukee, WI) |
| IOA | Isooctyl Acrylate | Sigma-Aldrich Chemical |
| | | Company (Milwaukee, WI) |
| TRPGDA | Tri(propylene glycol) Diacrylate | Sigma-Aldrich Chemical |
| | | Company (Milwaukee, WI) |
| CiA | Citronellyl Acrylate | Prepared according to Preparatory |
| | | Example 1 in U.S. Pat. Pub. No. |
| | | 2015/0037526 |
| Irgacure ® 651 | 2,2-dimethoxy-1,2-diphenyl ethan-1-one | BASF (Ludwigshafen, Germany) |
| Irgacure ® 1173 | 1-Propanone,2-hydroxy-2-methyl-1-phenyl- | BASF (Ludwigshafen, Germany) |
| HDDA | 1,6-Hexanediol Diacrylate | Sigma-Aldrich Chemical |
| | | Company (Milwaukee, WI) |
| PET | Polyethylene Terephthalate | Toray Plastics America (North |
| | | Kingstown, RI) |
| Silicone Release | MYLAR RSX951, 2 mil thick Silicone- | DuPont Teijin Films US |
| Liner 1 | coated PET Film | (Chester, VA) |
| PFA | Teflon ® PFA Film | DuPont Corp. (Wilmington, DE) |
| PTFE | Polytetrafluoroethylene Film | DuPont Corp., (Wilmington, DE) |
| FEP 6307 | 3M Dyneon ™ 6307 fluoropolymer | 3M Company (Maplewood, MN) |
| | (FEP) Film | |
| 5053 | 5053 fluoropolymer film | 3M Company (Maplewood, MN) |
| Silicone Release | Silicone-coated PET Film | Prepared generally according to |
| Liner 2 | | Example 1 of Pub. PCT App. WO |
| | | 2013/032771 |

### Test Methods

### Average Bead Diameter and Bead Density

Bead diameter and density of coated samples were measured by the analysis of micrographs. A microscope system with an incorporated digital camera was used to collect images of the structured coatings, and also to collect an image of a distance calibration slide. Images of the samples to be analyzed were imported into Microsoft Excel software and distances were measured by visually identifying the widest dimension of each feature and using the software to draw a line across this dimension. The length of the drawn line was reported from the software. This same process was completed for all of the larger beads in a selected area of an image, then the average of the length measurements was calculated.

Additionally, the area of analysis was computed by measuring the length and width of the analyzed area, then the Bead Density was calculated by dividing the total number of measured beads by the analyzed image area. The measured bead dimensions and the measured image area were calibrated by completing the same measurement process images of the length standard.

### Peel Test

Peel adhesion strength was measured at a 180° peel angle using an IMASS SP-200 slip/peel tester (available from IMASS, Inc., Accord Mass.) at a peel rate of 305 mm/minute. Stainless steel (SS) plates were prepared for testing by cleaning with acetone and a clean Kimwipe® tissue (Kimberly-Clark) one time followed by heptane and a clean Kimwipe® tissue three times. The cleaned panel was allowed to dry at room temperature. 3M Scotch Brand™ masking tape #233 was laminated to the back of the thin adhesive coated films for sample handling and support. The adhesive coated film with Masking tape 233 was cut into test samples measuring 2.54 cm×20 cm (1 in.×8 in.). A test sample was prepared by rolling the test samples down onto a cleaned panel with 2 passes of a 2.0 kg (4.5 lb.) rubber-coated roller. The prepared samples were held at 23° C./50% RH for 15 minutes before testing. Reported values are the average of two test samples for each example.

### Release Test

To form release test samples, a 25-micrometer-thick primed PET film was laminated to the discontinuous coatings that had been deposited and cured on a release liner substrate. The liner/adhesive/PET structure was cut into test samples measuring 2.54 cm×20 cm. The prepared samples were held at 23° C./50% RH for 15 minutes before testing. Release adhesion strength was measured using a 180° peel angle using an IMASS SP-2000 slip/peel tester (available from IMASS, Inc., Accord Mass.) at a peel rate of 228.6 cm/minute to separate the adhesive/PET from the liner. Reported values are the average of two test samples for each example.

### Contact Angle Testing

Measurements of the advancing and the receding contact angles in air of deionized, filtered water and IOA were made using the Wilhelmy plate method on a Radian DCA 322 dynamic contact angle instrument (ThermoCahn, Newington, N.H.). The surface tension of the deionized, filtered water was measured as 72.4 mN/m at 22° C. A three-layer laminate was prepared using 3M Scotch Brand™ #666 double-coated tape to mount the treated sides of the film outward. To prevent contamination during the preparation of this laminate, the treated surfaces only contacted untreated polypropylene film. This situation is analogous to the common practice of winding treated film into roll form after treatment.

The laminate was cut into a 2.54×2.54 cm square for analysis. The stage speed was 50 μm/s with a submersion distance of 10 mm. At the position of maximum travel, the motion of the stage was halted for 1 min prior to starting the retraction phase of the Wilhelmy cycle, thereby immersing the sample in water for a period of time. The volume of water used for the contact angle measurements was about 60 mL; a fresh volume of water was used for each sample analyzed. The advancing and receding contact angles were calculated using a software routine supplied with the ThermoCahn instrument that uses linear regression for the buoyancy correction. Typical standard deviations for the Wilhelmy contact angle measurements were +/−2°.

### Experimental Apparatus

The coating apparatus is described generally in U.S. Pat. No. 6,045,864. The coating apparatus creates coatings through the evaporation of a monomer mixture, the subsequent condensation of the vaporized monomer on a substrate surface, followed by the curing of the condensed liquid coating by exposure to a source of ultraviolet UV radiation. The coating apparatus used a syringe pump from Harvard Apparatus (Holliston, Mass.) to supply liquid monomer/oligomer mixture to a 60 kHz Ultrasonic Atomizing Nozzle, Model Q060-2-26-17-353-030, from SonoTek Corp. (Milton, N.Y.). The vaporized monomer/oligomer mixture was photopolymerized on the substrate using UVA or UVC Ultraviolet (UV) Lamps from Atlantic Ultraviolet (Happauge, N.Y.).

Monomer mixtures were pre-mixed prior to each coating experiment and were introduced to the system using the syringe pump feeding the ultrasonic atomizer. For all of the work reported herein, the vaporizer apparatus and the carrier nitrogen flow introduced to the vaporizer were pre-heated to 275° C. All of the reported experiments deposited a 10.5-inch-wide coating onto a 12-inch-wide transiting substrate.

In the coating apparatus, the substrate to be coated is unwound from a supply roll and continuously transported into the enclosure where the condensation coating and curing processes occur. After being exposed to the coating and curing, the coated substrate exits the purged enclosure and is collected on a roll. For the coatings reported herein, the release liner film was typically wound with the coated substrate, such that the release surface of this additional top liner contacted the patterned coating.

In certain examples, a corona pre-treatment was applied to the substrate prior to the condensation of the vaporized monomer on a substrate surface.

### Examples of Discontinuous Coatings

### Preparatory Example 1

### IOA:AA, No Crosslinker, Cured with UVA

A mixture of 90:10 isooctyl acrylate: acrylic acid with small amounts of either Irgacure® 651 or Irgacure® 1173 photoinitiator was deposited onto Silicone Release Liner 1 using the coating apparatus. For each of the coatings, the web was translated through the system at 0.5 m/min and the monomer mixture was introduced at varying rates. After being transported through the vapor condensation zone, the web was then was passed in front of six UVA bulbs, for an approximate UV residence time of one minute.

FIGS. 2A-2C show photomicrographs of the resulting coatings, corresponding to monomer flowrates of 1.0, 1.5, and 2.0 ml/min, respectively. The dimensions of the patterned features in the resulting coatings are listed in Table 2

TABLE 2

| Monomer | Average Bead | |
|---|---|---|
| Flowrate | Diameter | Bead Density |
| (ml/min) | (microns) | (Beads/mm²) |
| 1.0 | 64 | 108 |
| 1.5 | 96 | 58 |
| 2.0 | 145 | 35 |

### Preparatory Example 2

### Patterned Discontinuous Pressure Sensitive Adhesive (PSA) Coatings with Photoinitiator and Crosslinker

A mixture of 90:10 isooctyl acrylate: acrylic acid with 4% Darocur 1173 photoinitiator and 2% citronellyl acrylate (CiA) crosslinker was deposited onto Silicone Release Liner 1 using the coating apparatus.

For each of the coatings, the web was translated through the system at 0.5 m/min and the monomer mixture was introduced to the coating apparatus at varying rates. In each pass, the web was transported through the vapor condensation zone, then was passed in front of six UVC bulbs, for an approximate UV residence time of one minute.

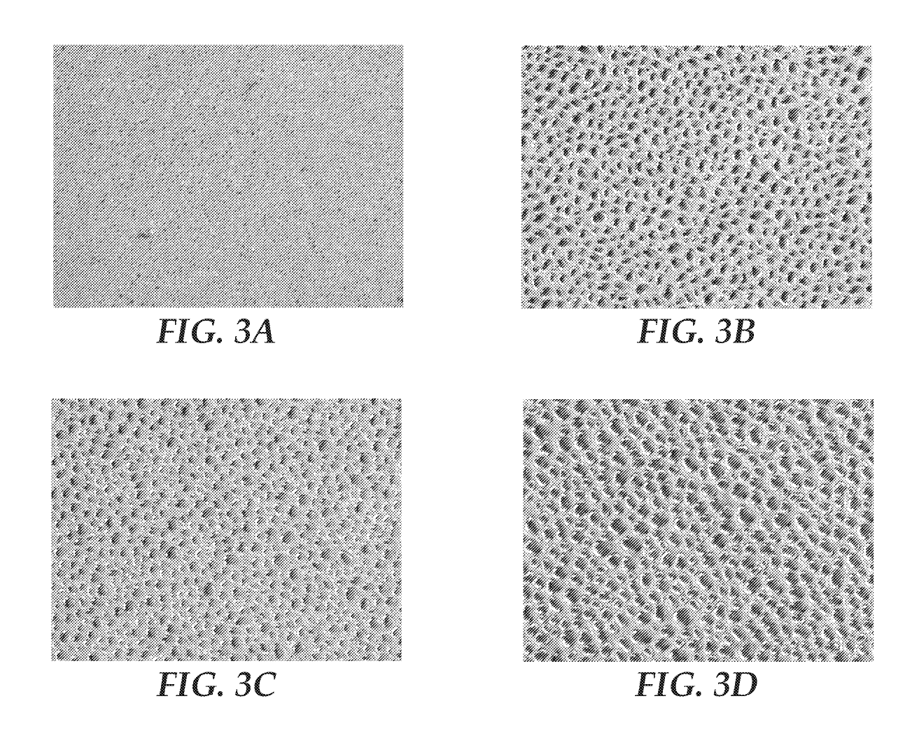

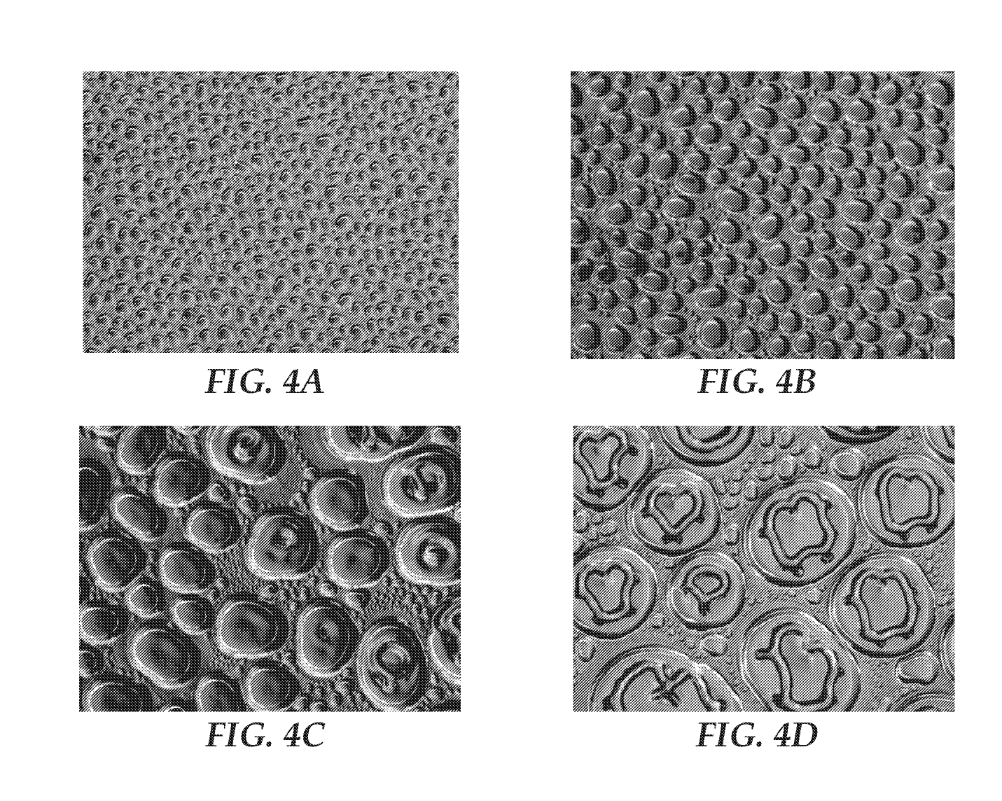

FIGS. 3A-3D and 4A-4D show photomicrographs of the resulting coatings, corresponding to a monomer flowrate of 0.5, 1.0, 1.25, 1.5; and 2, 3, 6 and 10 ml/min, respectively. These images of the deposited coatings demonstrate that this coating process produced “beaded” coatings and that the size of that the size of the “beads” or “islands” changed with the amount of the input monomer. The average bead diameter and bead density were calculated for the deposited coatings. Table 3 summarized the change in bead diameter and density with increasing monomer flow rate.

TABLE 3

| Monomer | Avg. Bead | |
|---|---|---|
| Flowrate | Diameter | Bead Density |
| (ml/min) | (microns) | (Beads/mm²) |
| 0.5 | 19 | 866 |
| 1.0 | 49 | 185 |
| 1.25 | 55 | 155 |
| 1.5 | 66 | 124 |
| 2 | 70 | 103 |
| 3 | 114 | 46 |
| 6 | 329 | 7 |
| 10 | 587 | 2 |

### Comparative Example A

A mixture of 90:10 isooctyl acrylate: acrylic acid with 4% Darocur 1173 photoinitiator and 2% citronellyl acrylate crosslinker was deposited onto a corona-treated 4.6 micron PET film using the coating apparatus. For each of the coatings, the web was translated through the system at 0.5 m/min and the monomer mixture was introduced to the coating apparatus at varying rates. In each pass, the web was transported through the vapor condensation zone, then was passed in front of six UVC bulbs, for an approximate UV residence time of one minute. The corona-treated PET had a degree of wetting high enough that the condensing vapor formed a continuous thin film on the surface, rather than a structured coating.

For the samples of Preparatory Example 2 and Comparative Example A, the peel force required to remove the adhesive from a steel surface was evaluated using the Peel Test. The results of the peel adhesions measurements are shown in Table 4.

TABLE 4

| Monomer | | | Adhesion to Steel |
|---|---|---|---|
| Flowrate | Release from Liner | Adhesion to Steel | Comparative |
| (ml/min) | (kg/cm) | (kg/cm) | (kg/cm) |
| 0.5 | 0.0031 | 0.0413 | 0.0525 |
| 1.0 | 0.0051 | 0.0759 | 0.1306 |
| 1.25 | 0.0059 | 0.1072 | |
| 1.5 | 0.0067 | 0.0938 | 0.1942 |
| 2.0 | — | — | 0.2623 |

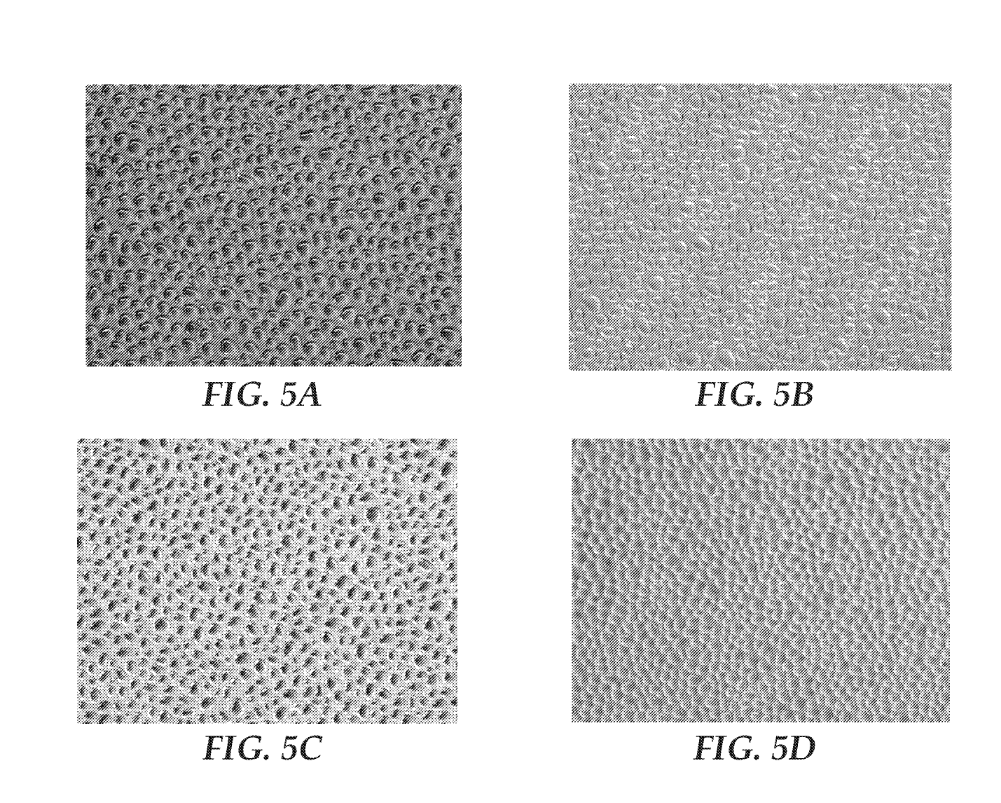

FIGS. 5A-5B show photomicrographs of the resulting coatings as deposited on silicone release liner 1 (FIG. 5A), and after transfer to a silica-sol primed PET substrate (FIG. 5B). For the coatings evaluated, there was almost complete transfer of the beaded adhesive from the liner material to the primed PET film, as shown in FIGS. 5A-5B. This complete transfer was typical of all the coatings, except that with thicker, larger-bead coatings, the small beads that formed in between the large beads often did not transfer.

The beaded PSA structure of the disclosure may also be transferred to a continuous adhesive surface, creating a thicker adhesive with a thin top structured surface. FIGS. 5C-5D shows a sample before and after this structured coating was transferred to a continuous PSA-coated film.

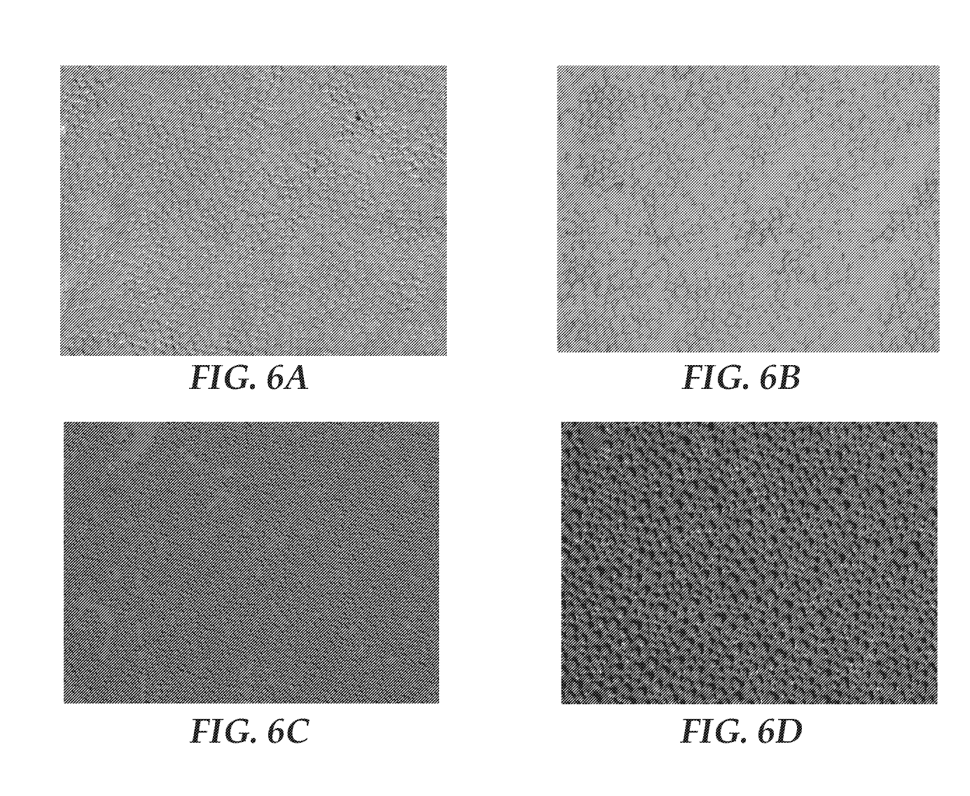

The beaded PSA structure can also be applied to a surface and laminated to another substrate to provide a continuous coating, as shown in FIG. 6A. FIG. 6A shows the beaded PSA structure of FIG. 5D transferred from the continuous adhesive surface to a glass slide and laminated. FIG. 6C shows the transferred coating after scraping with the edge of a razor blade to smooth or otherwise modify the surface of the transferred coating. These images were collected viewing through the glass slide to the adhesive-glass interface.

### Preparatory Example 3

### Beaded Patterned Discontinuous PSA Coatings—Changes with Contact Angle

To investigate the effect of substrate surface energy, the coating formulation of Preparatory Example #2 was used, and the Silicone Release Liner 2 was corona treated at varying levels prior to depositing a coating. The corona-treated surfaces were characterized by water contact angles prior to the deposition of the beaded coatings. Table 5 Summarizes the applied corona treatment level, and the correlated contact angle, bead diameter, and bead density.

TABLE 5

| | Advancing Water | Average Bead | |
|---|---|---|---|
| Corona Treatment | Contact Angle | Diameter | Bead Density |
| (J/cm²) | (°) | (μm) | (Dots/mm²) |
| 0.0 | 100 | 50 | 224 |
| 1.0 | 92 | 77 | 86 |
| 2.4 | 70 | 63 | 93 |
| 3.1 | 34 | 123 | 31 |
| 4.2 | 20 | 186 | 17 |
| 6.8 | 10 | 237 | 12 |

### Preparatory Example 4

### Beaded Patterned Discontinuous PSA coatings—Changes with Different Substrates Showing Feature Control by Changing Substrate Properties

A mixture of 90:10 isooctyl acrylate: acrylic acid with 1% Darocure 1173 photoinitiator and 0.5% HDDA was deposited onto different substrates using the coating apparatus. For each coating, web was translated through the system at 0.5 m/min, and in each pass, the web was transported through the vapor condensation zone, then was passed in front of six UVC bulbs, for an approximate UV residence time of one minute.

Samples of five different low-surface-energy films were attached to the carrier web and the condensation coatings were deposited onto these different materials. A summary of these coatings, showing the correlation of contact angle and bead diameter is shown in Table 6.

TABLE 6

| | IOA | IOA | Water | Water | | Average |
|---|---|---|---|---|---|---|
| | Advancing | Receding | Advancing | Receding | Bead | Bead |
| | Contact Angle | Contact Angle | Contact Angle | Contact Angle | Density | Diameter |
| Substrate | (°) | (°) | (°) | (°) | (Dots/mm²) | (μm) |
| PFA | 60 | 32 | 122 | 112 | 339 | 42 |
| PTFE | 51 | 40 | 116 | 107 | 222 | 52 |
| FEP 6307 | 56 | 43 | 118 | 116 | 282 | 46 |
| 5053 | 61 | 55 | 112 | 97 | 395 | 38 |
| Silicone Release | 33 | 26 | 109 | 103 | 74 | 89 |
| Liner 2 | | | | | | |
| Silicone Release | 39 | 18 | 109 | 106 | 118 | 75 |
| Liner 1 | | | | | | |

### Preparatory Example 5

### Beaded Discontinuous Coatings

A mixture of 97% Tri(propylene glycol) diacrylate (TRPGDA) and 3% Darocure 1173 inhibited to prevent premature polymerization was deposited onto Silicone Release Liner 1 using the above-described coating apparatus. For each of the coatings, the web was translated through the system at 0.5 m/min and the monomer mixture described above was introduced to the coating apparatus at varying rates. In each pass the web was transported through the vapor condensation zone, and then was passed in front of six UVA bulbs, for an approximate UV-exposure time of one minute.

Micrographs of the resulting coatings are shown in FIG. 6C-6D, corresponding to monomer flowrates of 1.0 ml/min and 2.0 ml/min, respectively. These images demonstrate that this coating process produced beaded coatings and that the size of the beads changes with the amount of the input monomer.

Reference throughout this specification to “one embodiment,” “certain embodiments,” “one or more embodiments” or “an embodiment,” whether or not including the term “exemplary” preceding the term “embodiment,” means that a particular feature, structure, material, or characteristic described in connection with the embodiment is included in at least one embodiment of the certain exemplary embodiments of the present disclosure. Thus, the appearances of the phrases such as “in one or more embodiments,” “in certain embodiments,” “in one embodiment” or “in an embodiment” in various places throughout this specification are not necessarily referring to the same embodiment of the certain exemplary embodiments of the present disclosure. Furthermore, the particular features, structures, materials, or characteristics may be combined in any suitable manner in one or more embodiments.

While the specification has described in detail certain exemplary embodiments, it will be appreciated that those skilled in the art, upon attaining an understanding of the foregoing, may readily conceive of alterations to, variations of, and equivalents to these embodiments. Accordingly, it should be understood that this disclosure is not to be unduly limited to the illustrative embodiments set forth hereinabove. In particular, as used herein, the recitation of numerical ranges by endpoints is intended to include all numbers subsumed within that range (e.g., 1 to 5 includes 1, 1.5, 2, 2.75, 3, 3.80, 4, and 5). In addition, all numbers used herein are assumed to be modified by the term “about.”

Furthermore, all publications and patents referenced herein are incorporated by reference in their entirety to the same extent as if each individual publication or patent was specifically and individually indicated to be incorporated by reference. Various exemplary embodiments have been described. These and other embodiments are within the scope of the following claims.

1. A method of making a discontinuous coating, comprising:
transiting a substrate through a vaporization area;
providing a reactant vapor comprising at least one vaporized monomer or oligomer to the vaporization area; and
chemically reacting the at least one vaporized monomer or oligomer to form a discontinuous layer on the substrate, optionally wherein chemically reacting further comprises polymerization.

2. The method of claim 1, wherein the substrate comprises a surface that comprises a surface energy that is less than a surface tension of the monomer or oligomer, optionally wherein the substrate comprises a release liner.

3-4. (canceled)

5. The method of claim 1, wherein the discontinuous layer is one of a patterned discontinuous layer, a semi-patterned discontinuous layer, or a random discontinuous layer.

6-10. (canceled)

11. The method of claim 1, wherein the reactant vapor further comprises at least one photoinitiator, optionally wherein the at least one photoinitiator is selected from 2,2-dimethoxy-1,2,-diphenyl ethan-1-one, 1,2-hydroxy-2-methyl-1-phenyl-1-Propanone, or a combination thereof.

12. (canceled)

13. The method of claim 1, wherein the at least one monomer or oligomer is selected from an alkyl acrylate monomer, an alkyl methacrylate monomer, an alkyl acrylate oligomer, an alkyl methacrylate oligomer, acrylic acid, methacrylic acid, or a combination thereof.

14-15. (canceled)

16. The method of claim 13, wherein the reactant vapor is substantially free of a crosslinker.

17-22. (canceled)

23. The method of claim 1, further comprising condensing at least a portion of the reactant vapor on a major surface of the substrate before reacting the at least one vaporized monomer or oligomer to produce the discontinuous layer.

24. The method of claim 23, wherein reacting the at least one vaporized monomer or oligomer comprises radiation curing the at least one vaporized monomer or oligomer by exposing the discontinuous layer to a radiation source selected from ultraviolet radiation, electron beam radiation, infrared radiation, radiation generated by a plasma discharge, or a combination thereof.

25-26. (canceled)

27. The method of claim 1, further comprising treating at least a portion of the substrate with a corona treatment, wherein an untreated portion of the substrate is obscured by a mask.

28. The method of claim 27, wherein the untreated portion of the substrate corresponds to a region of the substrate on which the discontinuous layer is formed optionally wherein the discontinuous layer is an adhesive layer.

29. (canceled)

30. The method of claim 1, wherein the discontinuous layer comprises a plurality of individual beads.

31. The method of claim 1, further comprising transferring the discontinuous layer to a surface.

32. (canceled)

33. A discontinuous coating, comprising:
a substrate; and
a layer of an at least partially cured discontinuous layer of at least one monomer or oligomer deposited on a portion of a surface of the substrate, wherein the thickness of the discontinuous layer is greater than zero micrometer, and less than about 250 micrometers optionally wherein the thickness of the discontinuous layer is from about 0.5 micrometer to about 10 micrometers.

34. (canceled)

35. The discontinuous coating of claim 33, wherein the discontinuous layer exhibits a visually identifiable pattern comprising a plurality of individual features optionally wherein each of the plurality of individual features exhibits a length that is greater than zero micrometers and less than 600 micrometers, and a width that is greater than zero micrometers and no greater than the length of that individual feature.

36. (canceled)

37. The discontinuous coating of claim 35, wherein the plurality of individual features exhibit a varying number of lengths and a varying number of widths, or wherein the plurality of individual features comprise a plurality of individual beads, optionally wherein each individual bead is hemispherical.

38. (canceled)

39. The discontinuous coating of claim 33, wherein an areal density of the plurality of features is between 900 features per millimeter squared (mm²), and 1 feature per mm².

40. The discontinuous coating of claim 33, wherein the discontinuous layer exhibits a peel force from steel, as measured using the Peel Test as defined herein, of at least about 0.01 kg/cm, and optionally no greater than about 0.5 kg/cm.

41. (canceled)

42. The discontinuous coating of claim 33, wherein the discontinuous layer exhibits a pattern formed by a plurality of individual features, optionally wherein each individual feature exhibits a random shape.

43. The discontinuous coating of claim 42, wherein the pattern comprises an orderly arrangement of at least a portion of the plurality of individual features.

44. The discontinuous coating of claim 33, wherein the discontinuous layer comprises a random arrangement of at least a portion of the plurality of individual features.
